(19) United States
(12) Patent Application Publication
(10) Pub. No.: US 2026/0118874 A1
(43) Pub. Date: Apr. 30, 2026

(54) SYSTEM FOR GUIDING MOBILE ROBOT TO STATION

(71) Applicant: SEOROBOTICS CO., LTD., Anyang-si, Gyeonggi-do (KR)

(72) Inventor: Hyo Seok BANG, Anyang-si, Gyeonggi-do (KR)

(21) Appl. No.: 19/478,812

(22) PCT Filed: Nov. 14, 2024
(86) PCT No.: PCT/KR2024/017935

§ 371 Date: Oct. 25, 2025

(30) Foreign Application Priority Data
Nov. 14, 2023 (KR) 10-2023-0157406

(51) Int. Cl. G05D 1/244; G05D 1/661

(52) U.S. Cl. CPC G05D 1/244; G05D 1/661

(57) ABSTRACT

Provided is a system for guiding a mobile robot to a station, the system including: a first face (11) on which a first marker (21) is formed; a second face (12) on which a second marker (22) is formed, the second face (12) being adjacent to the first face (11) and forming a first obtuse angle with the first face (11); and a third face (12) on which a third marker (23) is formed, the third face (13) being adjacent to the first face (11) on a side opposite the second face (12) and forming a second obtuse angle with the first face (11), wherein, when the mobile robot enters a station, at least one of the first, second, and third markers (21, 22, and 23) is captured by a camera of the mobile robot, even if the mobile robot is in an arbitrary position. The mobile robot recognizes and analyzes the first, second, and third markers (21, 22, and 23) in the captured image, generates an optimal travel path P based on the analysis results, and allows the mobile robot to be aligned in a correct posture to accurately dock with the station.

### TECHNICAL FIELD

The present invention relates to a system for guiding a mobile robot to a station by correctly correcting the posture of the mobile robot when the mobile robot is to dock with the station.

### BACKGROUND ART

Generally, a mobile robot may be manufactured to perform a designated function, may use battery power, and may be equipped with a device for performing a designated function.

The battery power is consumed as the mobile robot operates, and the mobile robot must be charged to continue operating.

In addition, the designated function of the mobile robot may require replenishing water, for example, in the case of fire suppression, or may require discharging collected dust and washing a mop, in the case of cleaning.

A station enables the mobile robot to automatically take measures necessary to continue performing its designated function.

The mobile robot may travel along a preset path or move to a destination while avoiding obstacles by analyzing information collected through a camera and various sensors, and must return to the station when the remaining battery level reaches a set value or when measures are needed to perform its designated function.

An existing system for guiding a mobile robot to a station will be described with reference to FIGS. 1 and 2. FIGS. 1 and 2 are diagrams for explaining an existing system for guiding a mobile robot to a station.

A target 10 is installed at the station, and one marker 20 is formed on a side wall of the target 10.

The marker 20 includes coordinate information. More specifically, when the marker 20 is captured by a camera, it is recognized by an image processor of the mobile robot. In image analysis, the marker 20 may be analyzed through marker recognition 30, and the marker recognition 30 may analyze recognition coordinates 40.

The recognition coordinates 40 include orientation information of an X-axis 41, a Y-axis 42, and a Z-axis 43, and based on this orientation information, the orientation posture of the mobile robot may be estimated.

The X-axis 41 is an axis indicating a direction perpendicular to and passing through a reference point of the marker 20, the Y-axis 42 is an axis indicating a horizontal direction from the reference point of the marker 20, and the Z-axis 43 is an axis indicating a vertical direction from the reference point of the marker 20.

In addition, the distance from the mobile robot to the marker 20 may be estimated using a distance sensor mounted on the mobile robot.

The mobile robot is equipped with a camera for capturing images, a distance sensor for detecting distances, and an image processing unit for analyzing camera images. The distance sensor may be a sensor that measures the distance to a measurement target.

When the mobile robot returns to the station, the approximate position coordinates of the station are pre-inputted, and it travels toward those position coordinates.

The mobile robot should enter the station in a preset approach posture, thereby allowing necessary measures to be taken for the mobile robot, such as charging the power supply, replacing consumables, or replenishing supplies as described above.

As the mobile robot travels autonomously, it may enter the station from an arbitrary position.

Regardless of its position, the mobile robot must align itself in the correct posture before the distance between the mobile robot and the station narrows to a set reference distance D. This allows the mobile robot to dock with the station.

An example of the mobile robot entering the station depending on the region in which it is located will be described with reference to FIG. 2.

A first region A1 is an area where the mobile robot's camera can capture the marker 20 from a nearly frontal position. The mobile robot can clearly recognize and analyze the marker 20 to analyze accurate position information, thereby allowing the mobile robot to align in the correct posture within the reference distance D and enter the station.

When the mobile robot is in the first region A1, it can clearly recognize the marker 20, which allows the mobile robot to align in the correct posture before reaching the reference distance D and enter the station.

A second region A2 is an area where the mobile robot's camera may capture the marker 20 at an angle.

When the mobile robot is in the second region A2, there is a possibility that it may not clearly analyze the information contained in the marker 20 even if it recognizes the marker 20, which poses a problem in that the mobile robot may fail to dock with the station.

A third region A3 is an area where the mobile robot's camera cannot capture the marker 20.

When the mobile robot is in the third region A3, it may not recognize the marker 20, and as a result, the mobile robot must repeatedly retreat and wander until it moves to an area where the marker 20 can be recognized, which poses a problem in that much time and remaining battery life are consumed in this process.

### RELATED ART DOCUMENTS

### Patent Documents

(Patent Document 1) KR 10-2559299 B1
(Patent Document 2) KR 10-2023-0097356 A
(Patent Document 3) KR 10-2436960 B1
(Patent Document 4) KR 10-2023-0117825 A
(Patent Document 5) KR 10-1828441 B1

### DISCLOSURE

### Technical Problem

Therefore, the present invention has been made in view of the above problems, and it is one object of the present invention to provide a system for guiding a mobile robot to a station, which allows the mobile robot to be aligned in a correct posture even when it approaches the station from an arbitrary position.

### Technical Solution

In accordance with an aspect of the present invention, the above and other objects can be accomplished by the provision of a system for guiding a mobile robot to a station, the system including: a first face 11 on which a first marker 21 is formed; a second face 12 on which a second marker 22 is formed, the second face 12 being adjacent to the first face 11 and forming a first obtuse angle with the first face 11; and a third face 12 on which a third marker 23 is formed, the third face 12 being adjacent to the first face 11 on a side opposite the second face 12 and forming a second obtuse angle with the first face 11, wherein, when the mobile robot enters a station, at least one of the first, second, and third markers 21, 22, and 23 is captured by a camera of the mobile robot, even if the mobile robot is in an arbitrary position.

In addition, in the system for guiding a mobile robot to a station according to an embodiment of the present invention, the first and second obtuse angles may be 120 degrees to 135 degrees.

Specific details of other embodiments are included in the detailed description and the accompanying drawings.

### Advantageous Effects

A system for guiding a mobile robot to a station according to an embodiment of the present invention has an effect in that, even if the mobile robot is in an arbitrary position when it approaches a station, it can recognize at least one of a plurality of markers, estimate the distance to the marker, and clearly ascertain the orientation posture of the mobile robot. Accordingly, the travel path of the mobile robot can be optimized, and the time it takes for the mobile robot to dock with the station can be reduced.

In particular, the system for guiding a mobile robot to a station according to an embodiment of the present invention has an effect in that it can recognize and analyze first, second, and third markers 21, 22, and 23 in an image captured by the mobile robot's camera, can quickly generate a travel path P based on the analysis results, and allows the mobile robot to be aligned in a correct posture to approach the station.

### DESCRIPTION OF DRAWINGS

FIGS. 1 and 2 are diagrams for explaining an existing system for guiding a mobile robot to a station.

FIGS. 3 and 4 are diagrams for explaining a system for guiding a mobile robot to a station according to an embodiment of the present invention.

FIG. 5 is a flowchart for explaining the operation of the system for guiding a mobile robot to a station according to an embodiment of the present invention.

FIG. 6 is an exemplary view for explaining the operation of the system for guiding a mobile robot to a station according to an embodiment of the present invention. Particularly, (a) of FIG. 6 is an example of recognizing two markers, (b) of FIG. 6 is an example of recognizing three markers, and (c) of FIG. 6 is an example of recognizing one marker.

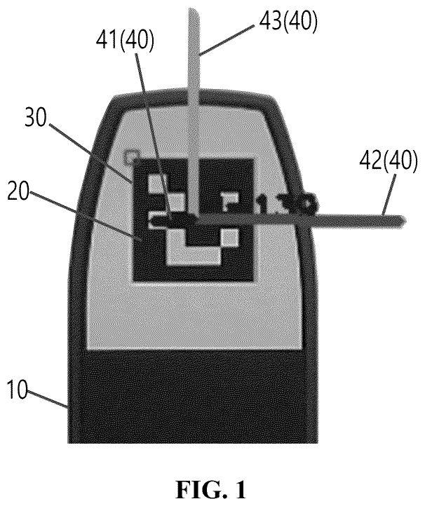

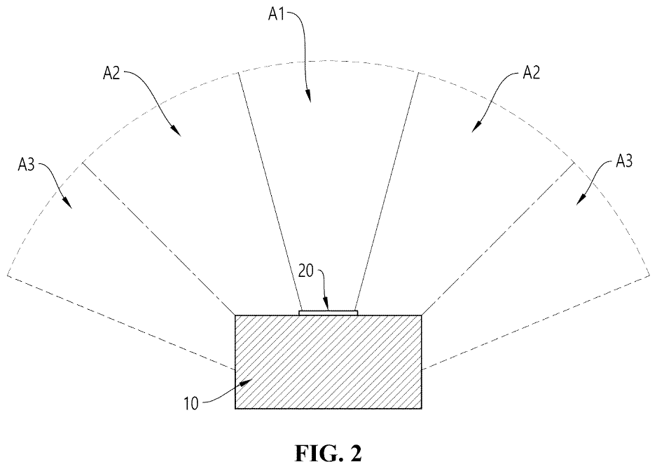

### BEST MODE

The advantages and features of the present invention and the method of achieving them will become apparent with reference to the embodiments described in detail below together with the accompanying drawings.

[Description of Symbols]

| | |
|---|---|
| 10: target | |
| 20: marker | 21, 22, 23: first, second |
| | and third markers |
| 30: marker recognition | 31, 32, 33: first, second |
| | and third marker recognition |
| 40: recognition coordinates | 41: X-axis |
| 42: Y-axis | 43: Z-axis |
| 100: mobile robot | |
| D: reference distance | P: travel path |

### Mode for Carrying out the Invention

Hereinafter, an embodiment of the present invention will be described in detail with reference to the accompanying drawings. The embodiment described below is provided as examples to help understand the present invention, and it should be understood that the present invention can be implemented in various ways different from the embodiment described herein. However, in the following description of the present invention, a detailed description of known functions and configurations incorporated herein will be omitted when it may make the subject matter of the present invention unclear. In addition, the accompanying drawings are not drawn to their actual scales and some components may be drawn with exaggerated sizes to help understand the invention.

Meanwhile, terms such as first, second, etc. may be used to describe various components, but the components should not be limited by the terms. The terms are used solely for the purpose of distinguishing one component from another. For example, without going beyond the scope of the present invention, the first component may be named the second component, and similarly, the second component may also be named the first component.

On the other hand, the terms described below are terms established in consideration of their functions in the present invention and thus may vary depending on the intention of a producer or custom. Accordingly, the definitions of the terms should be understood on the basis of the entire description of the present specification.

Throughout the specification, like reference numerals denote like elements.

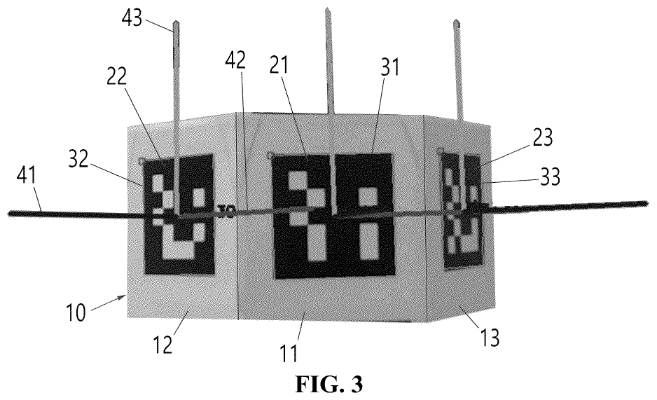

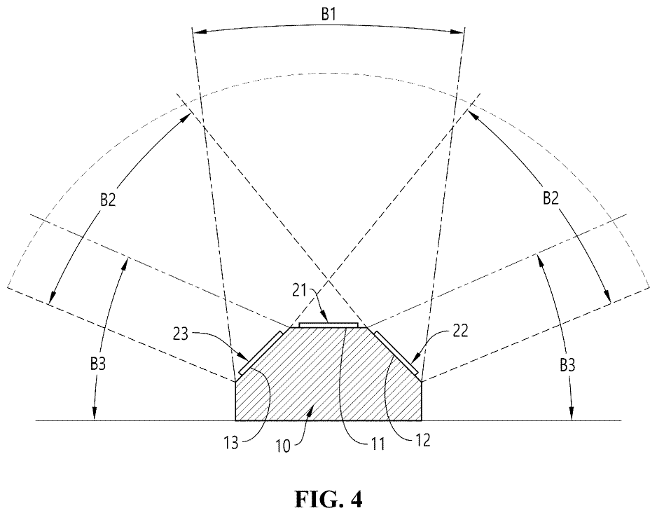

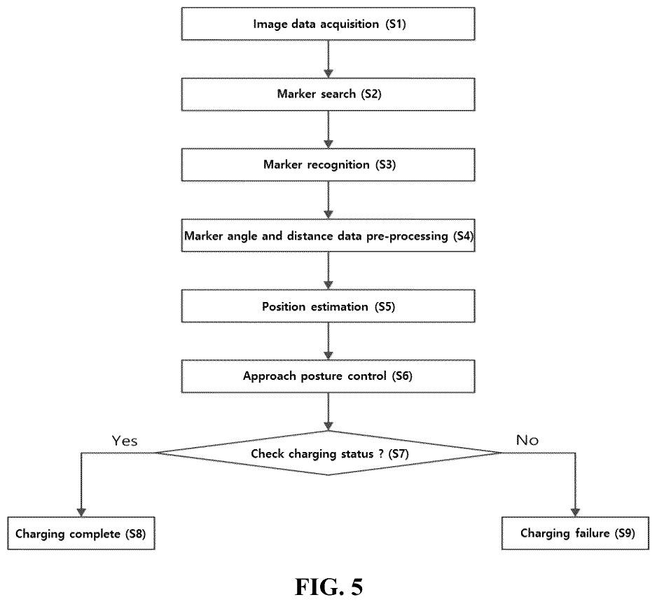

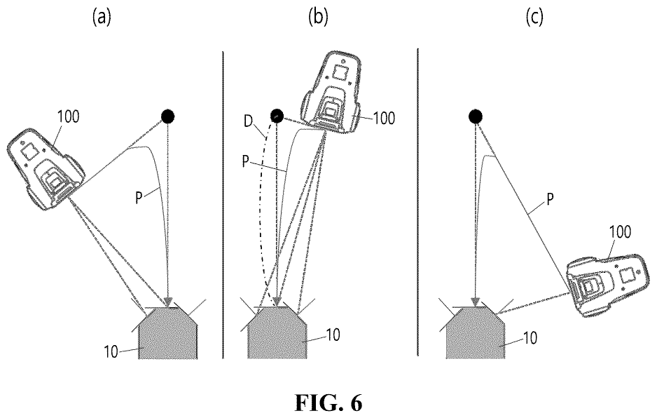

First, a system for guiding a mobile robot to a station according to an embodiment of the present invention will be described with reference to FIGS. 3 to 6. FIGS. 3 and 4 are diagrams for explaining the system for guiding a mobile robot to a station according to an embodiment of the present invention. FIG. 5 is a flowchart for explaining the operation of the system for guiding a mobile robot to a station according to an embodiment of the present invention. FIG. 6 is an exemplary view for explaining the operation of the system for guiding a mobile robot to a station according to an embodiment of the present invention. Particularly, FIG. 6(a) is an example of recognizing two markers, FIG. 6(b) is an example of recognizing three markers, and FIG. 6(c) is an example of recognizing one marker.

The system for guiding a mobile robot to a station according to an embodiment of the present invention has a target 10 with at least three faces. Here, a marker is formed on each face.

More specifically, the target 10 may be disposed at a station, and as shown in FIGS. 3 and 4, the target 10 may be formed with a first face 11, a second face 12, and a third face 13.

A first marker 21 is formed on the first face 11.

A second marker 22 is formed on the second face 12. The second marker 22 is adjacent to the first face 11 and forms a first obtuse angle with the first face 11.

A third marker 23 is formed on the third face 13. The third marker 23 is adjacent to the first face 11 on a side opposite to the second face 12 and forms a second obtuse angle with the first face 11.

The first, second, and third markers 21, 22, and 23 each have respective recognition coordinates 40. Since three markers are configured in an embodiment of the present invention, there are three types of recognition coordinates 40.

The recognition coordinates 40, from which three-dimensional coordinate information may be obtained, include the orientation information of an X-axis 41, Y-axis 42, and Z-axis 43, and the orientation posture of the mobile robot may be estimated based on the orientation information.

The X-axis 41 is an axis indicating a direction that perpendicularly passes through a reference point of a marker 20, the Y-axis 42 is an axis indicating a horizontal direction from the reference point of the marker 20, and the Z-axis 43 is an axis indicating a vertical direction from the reference point of the marker 20.

In other words, when a camera mounted on the mobile robot 100 captures the first, second, and third markers 21, 22, and 23, the recognition coordinates 40 may be determined by analyzing each of the first, second, and third markers 21, 22, and 23, as shown in FIG. 3.

Thereby, the orientation posture of the mobile robot 100, indicating the angle it forms with respect to the target 10 of the station, may be estimated.

In addition, the mobile robot 100 is equipped with a distance sensor, and thereby, the mobile robot 100 may estimate how far away it is from the target 10.

Alternatively, the distance between the mobile robot 100 and the target 10 may also be estimated by analyzing a captured image.

When the mobile robot 100 enters the station, even if the mobile robot 100 is in an arbitrary position, one or more of the first, second, and third markers 21, 22, and 23 may always be captured by the camera of the mobile robot 100, as shown in FIG. 4.

Meanwhile, the first and second obtuse angles may be between 120 degrees and 135 degrees.

The characteristics of each region where the mobile robot is located will be described with reference to FIG. 4.

When the mobile robot is in a first region B1, it may capture all of the first, second, and third markers 21, 22, and 23. In this case, as shown in FIG. 6(b), the mobile robot 100 may set the travel path P as the shortest distance, and the adjustment of the direction of travel may be minimized.

In particular, the X-axis 41 orientation value of the first marker 21 may converge to ‘0’, and if the X-axis 41 orientation value of the first marker 21 is ‘0’, it may be understood that the mobile robot 100 has docked at the correct position when docking with the station.

If the first and second obtuse angles are 120 degrees or more, the mobile robot 100 may accurately recognize all of the first, second, and third markers 21, 22, and 23 when it is in the first region B1.

When the mobile robot 100 is in the second region B2, it may recognize the first and second markers 21 and 22 by capturing them, or it may recognize the first and third markers 21 and 23 by capturing them.

For example, as shown in FIG. 6(a), the mobile robot 100 may be in the second region B2, skewed to one side with respect to the target 10. In this case, it may capture at least two markers and obtain three-dimensional coordinate information from each marker in the captured image.

From the three-dimensional coordinate information obtained at this time, it may be determined whether the mobile robot 100 is skewed to the left or to the right.

In other words, as shown in FIG. 6(a), when the mobile robot 100 is to the left of the target 10, the X-axis 41 and Y-axis 42 of each of the recognition coordinates 40 have positive (+) values. Accordingly, the travel path P may be set to allow the mobile robot 100 to move to the right and align itself such that the X-axis 41 value of the first marker 21 converges to ‘0’.

Meanwhile, if the distance between the mobile robot 100 and the target 10 is closer than a set reference distance D, the travel path P may be set to cause the mobile robot 100 to move backward so that the X-axis 41 value of the first marker 21 converges to ‘0’.

When the mobile robot 100 is in the third region B3, the first marker 21 may not be recognized, but the second marker 22 or the third marker 23 may be recognized.

For example, as shown in FIG. 6(c), the mobile robot 100 may be in a third region B3, excessively skewed to one side with respect to the target 10. In this case, it may capture at least one marker and obtain three-dimensional coordinate information from the marker in the captured image.

From the three-dimensional coordinate information obtained as described above, it may be determined whether the mobile robot 100 is skewed to the left or to the right.

As shown in FIG. 6(c), even if the mobile robot 100 is excessively skewed to the right with respect to the target 10, the mobile robot 100 may recognize the second marker 22. At this time, since the X-axis 41 and Y-axis 42 of the recognition coordinates 40 have negative (−) values, the travel path P may be set such that the X-axis 41 value of the first marker 21 converges to ‘0’.

Meanwhile, if the distance between the mobile robot 100 and the target 10 is closer than the set reference distance D, the travel path P may be set to cause the mobile robot 100 to move backward so that the X-axis 41 value of the first marker 21 converges to ‘0’.

If the first and second obtuse angles are 135 degrees or less, the mobile robot 100 may accurately recognize the first and second markers 21 and 22 or the first and third markers 21 and 23 when it is in the second region B2.

In addition, if the first and second obtuse angles are 135 degrees or less, the mobile robot 100 may accurately recognize the second marker 22 or the third marker 23 when it is in the third region B3.

In other words, in the system for guiding a mobile robot to a station according to an embodiment of the present invention, the mobile robot 100 may recognize at least one marker, even if it is in an arbitrary position, by forming the first and second obtuse angles to be between 120 and 135 degrees, and may generate an optimal travel path P by correcting the travel path P based on the X-axis 41 of the three-dimensional coordinate information of the recognized marker to correctly align the posture of the mobile robot 100.

The mobile robot 100 may perform functions at the station according to its designated function, such as charging, replenishing water, or emptying dust. A description will now be given assuming a charging scenario with reference to FIG. 5.
Step 1 (S1): The mobile robot 100 is equipped with a camera and collects image data captured by the camera.
Step 2 (S2): A marker is searched for in the captured image data. One, two, or three markers may be detected, and it may be understood that the more markers are detected, the more correct the posture of the mobile robot 100 is. Although the embodiment of the present invention presents three markers, more markers may also be arranged on planes having different angles from one another.
Step 3 (S3): This is a step of recognizing the marker from the detected markers. Each marker has its own three-dimensional coordinates and orientation values.
Step 4 (S4): The posture angle of the mobile robot 100 is estimated, and the distance from each marker to the mobile robot 100 is estimated and processed. The posture angle may be obtained from the X-axis 41, the Y-axis 42, or a combination of the X-axis 41 and the Y-axis 42 in the three-dimensional coordinates.
Step 5 (S5): The position of the mobile robot 100 may be estimated based on the distance from the target 10 and the posture angle formed by the target 10 and the mobile robot 100, with respect to the target 10.
Step 6 (S6): When the position of the mobile robot 100 with respect to the target 10 is specified, a travel path P is generated, and the posture of the mobile robot 100 is aligned as it moves along the travel path P. In particular, as the distance between the target 10 and the mobile robot 100 becomes closer than a set shortest distance D, the mobile robot 100 is corrected to an optimal, correct posture.
Step 7 (S7): When the mobile robot 100 has completed docking with the target 10, it processes the designated function. For example, if the mobile robot 100 is to be charged, charging may be performed by energizing charging terminals on both sides.

The charging state is checked, and if charging is performed normally, charging is completed (S8).

If the charging state is checked and charging is not proceeding normally, it is determined as a charging failure (S9) and a manager is notified. A method of notifying the manager uses known technology; for example, a text message or a voice message may be sent to a control room or a manager via wireless communication.

Alternatively, when determined as a charging failure (S9), the mobile robot 100 may detach from the station and then attempt to dock again.

While embodiments of the present invention have been described with reference to the accompanying drawings, a person skilled in the art to which the present invention pertains will understand that the present invention can be embodied in other specific forms without departing from its technical spirit or essential features.

Therefore, it should be understood that the embodiments described above are illustrative in all respects and not limiting. The scope of the present invention is defined by the appended claims, and all modifications or variations derived from the meaning and scope of the claims and their equivalents should be interpreted as being included within the scope of the present invention.

### INDUSTRIAL APPLICABILITY

A system for guiding a mobile robot to a station according to an embodiment of the present invention can be used for charging or maintaining a mobile robot.

1. A system for guiding a mobile robot to a station, the system comprising:
a target including:
a first face on which a first marker is formed;
a second face on which a second marker is formed, the second face being adjacent to the first face and forming a first obtuse angle with the first face and
a third face on which a third marker is formed, the third face being adjacent to the first face on a side opposite the second face and forming a second obtuse angle with the first face,
wherein the target is installed at a station, and when the mobile robot enters a station, at least one of the first, second, and third markers is captured by a camera of the mobile robot, even if the mobile robot is in an arbitrary position,
wherein the first marker, the second marker, and the third marker each include respective recognition coordinates,
the recognition coordinates including orientation information of an X-axis perpendicularly passing through a reference point of each marker, a Y-axis indicating a horizontal direction from the reference point, and a Z-axis indicating a vertical direction from the reference point, and the orientation information being used to estimate an orientation posture of the mobile robot,
wherein an orientation value of the X-axis of the first marker converges to ‘0’, and when the X-axis orientation value of the first marker is ‘0’, the system determines that the mobile robot has docked at a correct position in the station,
wherein, when the mobile robot is located to the left of the target, the X-axis and the Y-axis of each recognition coordinate have positive values, and a travel path is set such that the mobile robot moves to the right so that the X-axis value of the first marker converges to ‘0’,
wherein, when the mobile robot is present in a predetermined region other than the front of the target, the mobile robot captures at least one marker to obtain three-dimensional coordinate information, thereby identifying whether the mobile robot is skewed to the left or to the right with respect to the target,
wherein, when the distance between the mobile robot and the target is closer than a set reference distance, the travel path is set such that the mobile robot moves backward so that the X-axis value of the first marker converges to ‘0’,
wherein the mobile robot is equipped with a distance sensor, configured to estimate how far the mobile robot is from the target using the distance sensor, and
wherein the system for guiding a mobile robot to a station comprises the steps of:
collecting image data captured by the camera of the mobile robot;
searching for a marker in the captured image data;
recognizing the marker from the searched marker;
estimating a posture angle of the mobile robot and estimating and processing distances from each marker to the mobile robot;
estimating a position of the mobile robot with respect to the target based on the distance from the target and the posture angle formed between the target and the mobile robot;
generating a travel path when the position of the mobile robot with respect to the target is specified, and aligning the posture of the mobile robot as the mobile robot moves along the travel path; and
performing a designated function when docking of the mobile robot with the target is completed.

2. The system according to claim 1, wherein the first and second obtuse angles are 120 degrees to 135 degrees.
